(19) United States
(12) Patent Application Publication
(10) Pub. No.: US 2025/0249950 A1
(43) Pub. Date: Aug. 7, 2025

(54) STEERING COLUMN FOR A MOTOR VEHICLE

(71) Applicants: thyssenkrupp Presta AG, Eschen (LI); thyssenkrupp AG, Essen (DE)

(72) Inventor: Imre SZEPESSY, Mauren (LI)

(73) Assignees: thyssenkrupp Presta AG, Eschen (LI); thyssenkrupp AG, Essen (DE)

(21) Appl. No.: 19/041,693

(22) Filed: Jan. 30, 2025

(30) Foreign Application Priority Data
Feb. 1, 2024 (BE) BE 2024/5062

(51) Int. Cl. B62D 5/04; B62D 15/02

(52) U.S. Cl. CPC B62D 5/0406; B62D 15/0215; B62D 5/049

(57) ABSTRACT

A steering column for a motor vehicle comprises a steering spindle that is mounted in a sleeve unit so as to be rotatable about a longitudinal axis, is connected to an absolute angle sensor arranged in a sensor housing, and is coupled to a feedback actuator which has an electric motor that is connected to a control unit arranged in a control housing, wherein the motor has a relative angle sensor. In order to allow high operational reliability with less effort, the invention proposes that the control housing have higher sealing protection with respect to external influences than the sensor housing.

### CROSS REFERENCE TO RELATED APPLICATION

This application is a U.S. Non-Provisional that claims priority to Belgian Patent Application No. BE 2024/5062, filed Feb. 1, 2024, the entire content of which is incorporated herein by reference.

### FIELD

The present disclosure relates to a steering column for a motor vehicle, comprising a steering spindle that is mounted in a sleeve unit so as to be rotatable about a longitudinal axis.

### BACKGROUND

The invention relates to a steering column for a motor vehicle, comprising a steering spindle that is mounted in a sleeve unit so as to be rotatable about a longitudinal axis, is connected to an absolute angle sensor arranged in a sensor housing, and is coupled to a feedback actuator which has an electric motor that is connected to a control unit arranged in a control housing, wherein the motor has a relative angle sensor. The invention also relates to a method for operating such a steering column.

Steer-by-wire steering columns for motor vehicles receive manual steering commands from the driver in the same way as conventional mechanical steering systems by rotation of a steering wheel which is fitted at the driver-side rear end, in the direction of travel, of a steering spindle that is rotatable about its longitudinal axis in a sleeve unit. However, in contrast to conventional steering systems, the steering spindle is not mechanically connected to the steered wheels via a steering train via a steering gear, but cooperates with rotation sensors that sense the introduced steering command and output an electrical control signal, generated therefrom, to one or more electric steering actuators that set a corresponding steering angle of the wheels.

In steer-by-wire steering systems, the driver does not receive any direct mechanical feedback from the steered wheels via the steering train, which, in conventional mechanically coupled steering systems, is returned to the steering wheel as a reaction torque or feedback torque depending on the nature of the roadway, the vehicle speed, the current steering angle and further operating states via the steering gear and the mechanically continuous steering shaft. The missing haptic feedback makes it difficult to reliably sense current driving situations and to carry out intuitively appropriate steering manoeuvres, with the result that the vehicle steerability and thus driving safety can be adversely affected.

To create a realistic driving experience, provision is made, in a driving situation, for actual current parameters such as vehicle speed, steering angle, steering reaction torque and the like to be sensed metrologically or to be calculated in a simulation, and for a feedback signal to be formed therefrom, which is fed into the feedback actuator. The latter has an electric motor, the motor shaft of which is coupled to the steering spindle. During vehicle operation, the feedback signal is input into a control unit which electrically controls the motor in order to couple a corresponding feedback torque, corresponding to the actual reaction torque, into the steering wheel via the steering spindle. Such “force-feedback” systems give the drive the haptic impression of an actual driving situation as in a conventional steering system, thereby making an intuitive reaction easier.

In a generic steering column, an absolute value sensor is connected to the steering spindle, this being in the form of an absolute-value rotation angle sensor and outputting an electrical measured value corresponding to the angular position of the steering spindle relative to the sleeve unit. The relative rotation of the motor shaft of the motor of the feedback actuator is sensed by a relative angle sensor, which is in the form of a relative-value rotation angle sensor and, for example as an incremental encoder, converts a rotation angle into a defined electrical pulse sequence.

The motor is controlled by the control unit, which is structurally combined with the feedback actuator and has an electric control circuit. This is preferably also connected to the absolute value sensor and to the relative angle sensor.

In vehicles with an open passenger compartment, for example in offroad vehicles or convertibles, the steering column is exposed to relatively large external influences. This is increased by intensive cleaning of the vehicle, for example by means of a high-pressure water jet. In order to ensure, in this case, that the function is not impaired by penetrating moisture or solids, it is known to seal off the entire steering column from the outside. This results in high production and assembly costs, however.

Thus a need exists to address the problem of allowing high operational reliability with lower costs.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a schematic illustration of a steer-by-wire steering system.

FIG. 2 shows a schematic illustration of a feedback actuator according to the invention.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The invention relates to a steering column for a motor vehicle, comprising a steering spindle that is mounted in a sleeve unit so as to be rotatable about a longitudinal axis, is connected to an absolute angle sensor arranged in a sensor housing, and is coupled to a feedback actuator which has an electric motor that is connected to a control unit arranged in a control housing, wherein the motor has a relative angle sensor. The invention also relates to a method for operating such a steering column.

In the case of a steering column for a motor vehicle, comprising a steering spindle that is mounted in a sleeve unit so as to be rotatable about a longitudinal axis, is connected to an absolute angle sensor arranged in a sensor housing, and is coupled to a feedback actuator which has an electric motor that is connected to a control unit arranged in a control housing, wherein the motor has a relative angle sensor, the invention provides that the control housing has higher sealing protection with respect to external influences than the sensor housing.

According to the invention, the control unit is accommodated in a protected manner in the control housing with greater sealing with respect to external influences than the absolute angle sensor in the sensor housing. The higher sealing protection is defined in that greater resistance is set against the penetration of external influences, for example of moisture or solids acting from the outside on the steering column.

Put another way, the sensor housing and the control housing exhibit different sealing. This can be realized by differently formed sealing arrangements.

The control unit has an electronic control circuit which controls the motor on the basis of control signals that are transmitted, for example, externally from the steering controller to the feedback actuator in order to couple a driving-situation-dependent feedback torque into the steering spindle. Preferably, the control unit can electrically read the relative angle sensor of the motor in order to sense the rotation of the motor shaft as a relative angle measured value. To this end, the relative angle sensor may have, for example, an incremental encoder or the like, which converts a rotational angle into a defined pulse sequence.

The invention is based on the finding that the control unit, which is relatively sensitive to external disruptive influences, has to be protected particularly reliably from external influences, while relatively lower protection of the absolute angle sensor suffices in order to ensure reliable operation of the steering system. This allows an adapted design of the sealing protection, wherein relatively high sealing protection is provided only for the control unit, and the sealing protection of the absolute angle sensor is relatively less complicated compared therewith.

The advantage of the sealing protection that is designed in a requirement-dependent manner according to the invention is that the production and assembly costs of the steering column can be reduced.

The reduced sealing protection can be compensated by the method according to the invention, by way of which less probable disruption of the absolute angle sensor by external influences can also be sensed and compensated, and so high operational reliability is ensured.

Provision may preferably be made for the higher sealing protection to be predefined by a higher degree of protection. The degree of protection specifies a standardized housing protection with respect to the penetration of water and foreign bodies, which is defined, for example, by the International Standard ISO 20653 relating to the protection of electrical equipment of road vehicles. According to the invention, the control housing has a higher degree of protection than the sensor housing.

The degree of protection of the control housing is preferably configured to be robust, in order to close it off in a dustproof manner and to ensure protection from the penetration of water during high-pressure and steam-jet cleaning. This corresponds to the standardized protection class IP69 according to ISO 20653.

By contrast, according to the invention, less resistant protection can be realized for the sealing off of the absolute value sensor in the sensor housing, for example merely protected against dust and with protection from water that is incident from all sides or spray. This corresponds, for example, to an ISO protection class IP54, or IP45 or lower.

As a result of the adapted protection, the electric control unit is also protected from high loads, which can arise, for example, during high-pressure water-jet cleaning.

The absolute value sensor is less sensitive to moisture, and so a lower degree of protection suffices, even though, as a result, a certain amount of moisture can pass into the sensor housing in the event of high external stresses.

The main advantage of the invention is that the costs for sealing the absolute value sensor can be lower, with the result that the production and assembly costs for the steering column as a whole can be reduced.

It is possible for the control unit to be arranged in a hermetically sealed manner in the control housing. Hermetic sealing may be realized, for example, by elastic soft seals or cohesively introduced sealing compounds at all housing gaps, being designed to be dustproof and liquid-tight with regard to all external influences that are expected. As a result, a sufficiently high sealing class can be realized, which affords reliable protection even from extreme loads, for example caused by high-pressure or steam-jet cleaning.

Provision may be made for the control housing to be connected in a sealed manner to a motor housing of the motor. The control housing may be designed to be open on one side, for example by way of a hood-, cup- or box-like design with an opening which is closed by the sealed attachment to the motor housing. This allows relatively simple assembly.

It is possible for the control housing to be formed in an integrated manner with the motor. The motor may have, for example, a motor housing in which the rotor is mounted so as to be rotatable about the motor axis, which motor housing is closed so as to be sealed with respect to the outside and in which the control unit is arranged. The control housing may be realized by a sealed-off interior of the motor housing. This allows a compact and space-saving construction.

The absolute angle sensor may be connected coaxially to the steering spindle. Preferably, it may be connected to the steering spindle and the sleeve unit.

It may be advantageous for the sensor housing to be connected to the sleeve unit. The sensor housing may, for example, be placed on a sleeve housing of the sleeve unit, in which sleeve housing the steering spindle is mounted. In this case, the interior of the sensor housing is closed off so as to be less sealed with respect to the outside than the interior of the control housing. The sensor housing may have sealants that are less complicated with respect to the action of liquid from the outside, or have no additional sealants. For example, a simple flange connection or the like may be provided, wherein, between the sensor housing and the sleeve unit, a simpler seal or no additional soft seal may be inserted.

The sensor housing may be formed in an integrated manner with the sleeve unit. In this case, the absolute angle sensor may be arranged in the sleeve unit, for example in a sleeve housing of the sleeve unit, in which sleeve housing the steering spindle is mounted.

Preferably, provision is made for the motor to be coupled to the steering spindle via a gear. The rotationally drivable motor shaft is connected to the steering spindle in a torque-transmitting manner via the gear. The gear may preferably be in the form of a reduction gear in order to drive the steering spindle with a reduced steering spindle speed relative to the motor speed. The gear may have a belt gear or a timing belt gear which has a drive gear connected to the motor shaft and an output gear connected to the steering spindle, with a circulating belt or timing belt. Alternatively or additionally, a spur gear, worm gear or the like can be provided.

It is advantageous for the gear to have a gear housing which is connected to the motor and the sleeve unit. In the gear housing, which is preferably designed in a closed manner, the gear elements, for example a timing belt drive, can be accommodated in a protected manner.

It is possible for the sensor housing to be connected to the gear. The sensor housing may be fitted on the gear housing, preferably in the region of the output side of the gear, coaxially with the steering spindle. Alternatively, it is conceivable and possible for the sensor housing to be formed in an integrated manner with the gear housing. The gear housing may preferably be connected to the sleeve unit, for example to a sleeve housing of the sleeve unit.

It is possible for the motor to have a motor shaft that is arranged parallel to the longitudinal axis at a distance therefrom. This allows a space-saving and efficient construction.

Provision may preferably be made for the absolute angle sensor and the relative angle sensor to be connected to the control unit. As a result, the measured values of the angular positions of the steering spindle and of the motor shaft can be sensed and used to control the feedback actuator.

In the abovementioned embodiment, it is advantageous for the control unit to have a comparison unit. The rotation of the motor shaft is clearly correlated with the rotation of the steering spindle by the mechanical coupling, corresponding to the transmission ratio when a gear is interconnected. By comparing the measured values provided by the absolute angle sensor and the relative angle sensor, it is possible to check operation. If the comparison reveals, for example, that the relative angle sensor is indicating rotation of the motor shaft but the absolute angle sensor is outputting no absolute angle signals or absolute signals that deviate from the transmission ratio, this can indicate a fault in the absolute angle sensor. In this way, it is possible to ensure that, even in the unlikely event that the operation of the absolute angle sensor is impaired for example by penetrating moisture, a fault is identified, in order for it to be possible to promptly take safety measures. This ensures that even a sealing protection of the absolute angle sensor that is lower according to the invention does not have an adverse effect on operational reliability.

Preferably, the steering column may be in the form of a steer-by-wire steering column. In this case, the steering spindle does not have a mechanical connection to the steerable wheels. The absolute angle sensor senses a steering command, manually input by rotation of the steering spindle, as an electrical control signal by which one or more electromotive steering actuators are controlled to create a mechanical steering angle of the steerable wheels of the vehicle. In addition, further rotation sensors may be provided, for example to sense a manual steering torque.

The invention comprises a method for operating a steering column according to any of the above-described embodiments, wherein provision is made for a change in a steering angle, sensed by the absolute angle sensor, of the steering spindle to be compared with a change, sensed by the relative angle sensor, in the rotation of the motor shaft of the motor, and in the event of a deviation from a predefined reference ratio, for a fault message to be output.

The method according to the invention may expressly comprise all the features and procedures that have expressly or implicitly been mentioned above in connection with the steering column according to the invention.

In the method according to the invention, a comparison is used to check whether a rotation, sensed by the relative angle sensor, of the motor shaft is correlated with a rotation, sensed by the absolute angle sensor, of the steering spindle, as is defined according to the mechanical coupling, for example corresponding to the transmission ratio. The comparison of the absolute angle and relative angle measured values may preferably take place in a comparison unit, which may preferably be integrated in the control unit, as is described above for the steering column.

In the different figures, the same parts are always provided with the same reference signs and are therefore, as a rule, also each only mentioned once.

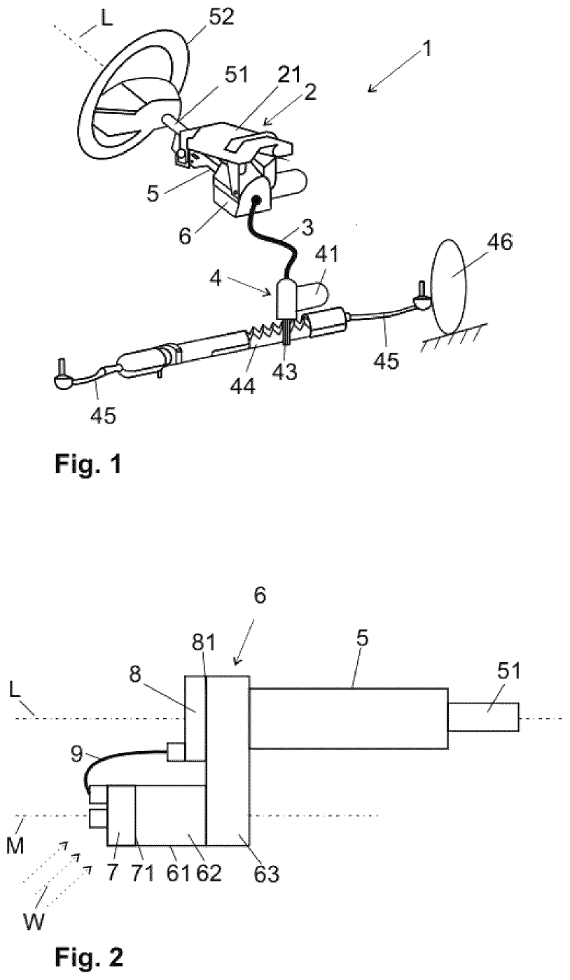

FIG. 1 schematically shows a steer-by-wire steering system 1, which comprises, as input unit, a steering column 2, which is in the form of a steer-by-wire steering column. This is connected to the electric steering actuator 4 via an electric line 3.

The steering actuator 4 comprises a servomotor 41 which is connected to the electric line 3 and introduces a steering actuating torque into a steering gear. There, the steering actuating torque is converted, via a pinion 43 and a rack 44, into a translational movement of track rods 45, with the result that a steering angle of the steered wheels 46 is brought about in a manner known per se by pivoting steering knuckles. Alternatively, the steered wheels 46 can be connected to individually controllable electric steering actuators in order to realize single wheel steering.

The steering column 2 has a sleeve unit 5, which is held by a support unit 21 which is able to be fitted on a vehicle body (not shown). In the sleeve unit 5, a steering spindle 51 is mounted so as to be rotatable about a longitudinal axis L. At the rear end with regard to the direction of travel, a steering wheel 52 is fitted as a manual steering input means.

In the front region with regard to the direction of travel, a feedback actuator 6 according to the invention is fitted on the sleeve unit 5, the feedback actuator being shown schematically in an exposed manner in FIG. 2.

The feedback actuator 6 has an electric motor 61, which has a motor shaft that is mounted in a motor housing 62 and is able to be driven in rotation about a motor axis M. The motor axis M is arranged parallel to the longitudinal axis L at a distance therefrom.

The motor shaft of the motor 61 is coupled to the steering spindle 51 in a torque-transmitting manner via a gear 63. The latter may be, for example, in the form of a timing belt gear.

Fitted on the motor 61 is a control housing 7, in which an electronic control unit is arranged. Connected to the latter is a relative angle sensor that is integrated in the motor 61 and has, for example, an incremental encoder which converts a relative rotation of the motor shaft into an electrical pulse sequence.

The feedback actuator 6 has a sensor housing 8, in which an absolute angle sensor is arranged which is in the form of an absolute-value rotation angle sensor and cooperates with the steering spindle 51 such that it outputs an electrical measured value corresponding to the angular position of the steering spindle 61 relative to the sleeve unit 5.

In the example shown, the sensor housing 8 is connected to the gear 63, which for its part is connected to the sleeve unit 5. Alternatively, the sensor housing 8 can be fitted directly on the sleeve unit 5 or be formed in an integrated manner therewith.

The control housing 7 is fitted on the motor 61 so as to be sealed off from the outside, preferably with high, robust sealing protection, for example in a dustproof manner and so as to be protected from the penetration of water in the case of a high-pressure water jet W acting from the outside, this being schematically indicated. As a result of suitable sealing measures, such as sealants 71—for instance elastic soft seals or cohesively introduced sealing compounds—arranged between the control housing 7 and the motor 61, it is possible, for example, for an ISO protection class IP69 to be realized.

According to the invention, the sensor housing 8 has lower sealing protection than the control housing 7; for example, the connecting point 81 with the gear 63 or the sleeve unit 5 can be in the form of a flange connection without additional sealant. As a result, it is possible, for example, for an ISO protection class IP54, IP45 or lower to be realized.

The absolute angle sensor accommodated in the sensor housing 8 is connected, in the example shown, via a connecting cable to the control unit arranged in the control housing 7. According to the invention, this is guided through into the control housing 7 while ensuring the high sealing protection, whereas lower sealing protection can be provided when it is guided through into the sensor housing 8.

### LIST OF REFERENCE SIGNS

1 Steering system
2 Steering column
3 Line
4 Steering actuator
41 Servomotor
43 Pinion
44 Rack
45 Track rod
46 Wheel
5 Sleeve unit
51 Steering spindle
52 Steering wheel
6 Feedback actuator
61 Motor
62 Motor housing
63 Gear
7 Control housing
71 Sealant
8 Sensor housing
81 Connecting point
9 Connecting cable
L Longitudinal axis
M Motor axis
W Water jet

1. A steering column for a motor vehicle, comprising:
a steering spindle that is mounted in a sleeve unit so as to be rotatable about a longitudinal axis, is connected to an absolute angle sensor arranged in a sensor housing, and is coupled to a feedback actuator which has an electric motor that is connected to a control unit arranged in a control housing, wherein the motor has a relative angle sensor;
wherein the control housing has higher sealing protection with respect to external influences than the sensor housing.

2. The steering column according to claim 1, wherein the higher sealing protection is predefined by a higher degree of protection.

3. The steering column according to claim 1, wherein the control unit is arranged in a hermetically sealed manner in the control housing.

4. The steering column according to claim 1, wherein the control housing is connected in a sealed manner to a motor housing of the motor.

5. The steering column according to claim 1, wherein the control housing is formed in an integrated manner with the motor.

6. The steering column according to claim 1, wherein the absolute angle sensor is connected coaxially to the steering spindle.

7. The steering column according to claim 1, wherein the sensor housing is connected to the sleeve unit.

8. The steering column according to claim 1, wherein the motor is coupled to the steering spindle via a gear.

9. The steering column according to claim 8, wherein the gear has a gear housing which is connected to the motor and the sleeve unit.

10. The steering column according to claim 8, wherein the sensor housing is connected to the gear.

11. The steering column according to claim 1, wherein the motor has a motor shaft that is arranged parallel to the longitudinal axis at a distance therefrom.

12. The steering column according to claim 1, wherein the absolute angle sensor and the relative angle sensor are connected to the control unit.

13. The steering column according to claim 12, wherein the control unit has a comparison unit.

14. The steering column according to claim 1, wherein the steering column is in the form of a steer-by-wire steering column.

15. A method for operating a steering column according to claim 1, wherein a change in a steering angle, sensed by the absolute angle sensor, of the steering spindle is compared with a change, sensed by the relative angle sensor, in the rotation of the motor shaft of the motor, and in the event of a deviation from a predefined reference ratio, a fault message is output.
